(19) United States
(12) Patent Application Publication
(10) Pub. No.: US 2026/0213435 A1
(43) Pub. Date: Jul. 23, 2026

(54) CONNECTING TERMINAL WITH A CLAMP SPRING WHEREIN THE ACTUATOR THEREOF CAN BE ENGAGINGLY ATTACHED

(71) Applicant: HARTING ELECTRIC STIFTUNG & CO. KG, Espelkamp (DE)

(72) Inventor: Christof HERMONI, Rahden (DE)

(21) Appl. No.: 18/716,480

(22) PCT Filed: Nov. 25, 2022
(86) PCT No.: PCT/DE2022/100883

§ 371 Date: Jun. 4, 2024

(30) Foreign Application Priority Data
Dec. 6, 2021 (DE) 10 2021 132 063.1

(51) Int. Cl. H01R 4/48

(52) U.S. Cl. CPC H01R 4/4842; H01R 4/4835; H01R 4/489

(57) ABSTRACT

A connecting terminal is provided, including a contact carrier and at least one conductor rail, as well as at least one actuator that can be engagingly attached to the contact carrier in an actuated position, wherein the actuator has two flexible sections which can be bent apart for engaging the actuator in the actuated position on the contact carrier and wherein the actuator can be actuated with a slot screwdriver and translationally moved into a guide channel of the contact carrier in order to actuate a spring clamp of the connecting terminal in the actuated position. In the non-actuated position of the actuator, the clamping portion of the spring clamp presses a cable against a contact region of the conductor rail in order to electrically conductively connect the cable and the conductor rail to the contact region, and to mechanically clamp them on the contact region.

### BACKGROUND

### Technical Field

Embodiments of the present disclosure relate to a cable connecting device having at least one contact carrier, at least one clamp spring, and at least one conductor rail, as well as at least one actuator which, in an actuated position, can be latched to the contact carrier.

An actuator for a cable connecting device is also provided.

Cable connecting devices and actuators of this type are required in order to be able to connect at least one electrical conductor to the at least one conductor rail in an electrically conducting manner and with as little manual effort as possible, and to mechanically fix said electrical conductor in relation to undesirable extraction, yet so as to be able to release the electrical conductor from the conductor rail again with only little manual effort if required.

### Description of the Related Art

Publication DE 198 23 648 C1 shows a connecting terminal in which a plugged-in conductor is resiliently clamped between a fixedly established connecting contact and a clamping edge of a clamp spring that engages below the connecting contact. A wedge-shaped actuating member is disposed so as to be displaceable in the housing of the connecting terminal in order to lift the clamping edge from the connecting contact in order to introduce the conductor. The wedge-shaped actuating member comprises a compression face and a wedge face which is disposed at an acute angle to the latter. In one displaced position, the actuating member presses down a spring leg of the clamp spring, while the actuating member releases the spring leg in the other displaced position. The wedge face of the actuating member comprises a latching edge by way of which the actuating member in the open position latches into a recessed latching clearance of an internal wall of the contacting terminal under the spring force of the spring leg. For moving to the clamping position, the actuating member is lifted out of the latching mechanism in the latching clearance counter to the force of the spring leg.

One disadvantage is that the actuating member has to be lifted out of the latching receptacle counter to the force of the spring leg by a minor pivoting movement of the tool, i.e., of a screwdriver or the like, in order to move the contacting terminal to the clamping position. Therefore, this method is less suitable for comparatively long translatory travel distances of the actuator, such as are encountered in systems with V-shaped clamp springs, for example, and said method is explicitly mentioned in the context of a cage clamp.

Proceeding therefrom, publication DE 10 2007 050 683 B4 is based on the object of achieving an improved conductor connecting terminal having a housing of insulation material in which push actuators of various types which can be fixedly established in at least one unlocking position can be integrated. For this purpose, this publication proposes to guide the push actuator in a guide channel, wherein a concavity provides a void in the guide channel in such a way that a portion of the push actuator can be repositioned in order to fixedly establish the push actuator in the unlocking position. Equipping the guide channel having the concavity with a suitable push actuator is the responsibility of the manufacturer. Furthermore, a plurality of different variants of push actuators for this purpose are disclosed. One of these variants provides that the push actuator has a flexible portion between that portion that can be fixedly established in the concavity and that portion that interacts with the spring-force clamping contact. This flexible portion permits pivoting of the push actuator to one side, into the concavity in the guide channel.

In this variant too, two translatory movements have to be performed with the tool by the user during the locking actuation, specifically an actuating movement and—in the already introduced state—a locking movement perpendicular to the actuating direction, this requiring a certain degree of dexterity and an understanding of the corresponding mechanism. Because the latching action of the actuator only takes place on one side of the channel, the direction of latching is not apparent, or at least not self-evident, to the user, because the user cannot see into the interior of the contact carrier during actuation. A further decisive disadvantage of this construction mode lies in that specifically the central part of the actuator, which is subjected to high mechanical stress during actuation, also needs to have a high degree of stability as well as the required elasticity. In the locked state in particular, this bent region is subjected to high mechanical stress and corresponding wear due to the spring force. Moreover, that portion of the actuator that serves for guiding the latter in the housing is inevitably of only a very short embodiment, which impedes the guiding action.

Furthermore, various publications, for example publication DE 10 2017 127 001 B3, disclose a substantially V-shaped spring-force clamp having an actuating element which latches to the housing by way of tilting under the effect of a spring force, so as to keep the clamp spring in its open position.

This variant exacerbates the issue that the actuator fundamentally loses its guiding action as a result of being tilted, at least in its actuated state. Furthermore, two translatory movements have to be carried out by the tool during the locking actuation in this case also, specifically an actuating movement and—in the already introduced state—a locking movement perpendicular to the actuating direction.

Finally, publication DE 10 2008 039 232 B4 discloses an actuator which is round in cross section, i.e., substantially cylindrical, which, as a result of its rotation, is able to be locked by a latching pin integrally molded on the cylindrical external face of said actuator, without the latter losing its guiding action. However, it is disadvantageous herein that said actuator, as a result of its round/cylindrical fundamental shape, cannot by nature have a large-area common contact region with the clamp spring, which is usually in the fashion of a leaf spring. In this way, valuable installation space is wasted by the cylindrical shape and the rotatability of the actuator, because the leaf spring cannot be received by the actuator, e.g., in a cavity of the actuator.

### BRIEF SUMMARY

Embodiments of the present disclosure provide a compact cable connecting device which is both intuitive and comfortable to operate and has a sufficiently stable actuator.

A cable connecting device has a contact carrier and at least one conductor rail. The cable connecting device includes at least one actuator which, in an actuated position, is latchable to the contact carrier. The actuator includes at least two flexible portions that are able to be bent apart for latching the actuator to the contact carrier.

“Able to be bent apart” herein and hereunder means that the two flexible portions are “able to be bent away from one another.”An actuator for the cable connecting device has two flexible portions which are able to be bent apart for latching the actuated actuator to the contact carrier.

In some embodiments, guiding of the actuator is not lost for latching and continues to be able to be latched simultaneously on two, mutually opposite, sides.

In one embodiment, the actuator is actuatable by a tool, such as a flat-head screwdriver, and in the process able to be moved in a translatory manner into a guide channel of the contact carrier so as to actuate a clamp spring, for example.

The cable connecting device serves to press an electrical conductor, for example a strand of an electrical cable introduced into the contact carrier, against the conductor rail by the clamp spring, and in this way connect the strand to said conductor rail in an electrically conducting manner and mechanically hold it thereon. With the so-called “push-in” technical solution, it suffices here to plug the electrical conductor into the conductor rail so that said electrical conductor slides between a clamping leg of the V-shaped clamp spring and a contact portion of the conductor rail, and is secured in a clamping manner in relation to extraction counter to the introduction direction of said electrical conductor between a clamping leg of the clamp spring and a contact region of the conductor rail. This push-in technical connection solution is operator-friendly because the manual effort is very minor and can be readily performed by the user with two hands. In this instance, the actuator serves only for releasing the connection should there be a corresponding requirement, this being performed in that the actuator presses down the clamping leg of the clamp spring.

However, this method also requires a sufficiently stiff and stable electrical conductor. A strand is not usually able to offer this stability. Therefore, the strand needs to be provided with a strand end sleeve.

However, if a thin strand, such as with a cross section of less than 1.5 mm, for example, is inserted without a strand end sleeve, it can occur that said strand is not capable of bending the clamping leg of the V-shaped clamp spring away from the contact face of the conductor rail, for example. In this case, the actuator is assigned a second function in which it actuates the clamping leg so that this thin strand can be inserted in the first place. If the actuator is now released again, this thin strand can also be fixedly clamped on the contact face of the conductor rail by the clamping leg, and can be connected to said contact face in an electrically conducting manner and be secured against inadvertent extraction.

However, this can only be performed very uncomfortably when using two hands, because the contact carrier and the cable have to be held and the actuator has to be simultaneously actuated.

As a result of the present disclosure however, the actuator can be latched in its actuated state. In this way, the actuator does not have to be actuated simultaneously but only prior to the introduction of the thin strand, and has only to be unlatched after the introduction of the strand, this representing a significant improvement in terms of operating comfort in comparison to the set of issues mentioned above, as is described by way of example hereunder.

For example, such a procedure can be carried out as follows by a right-hander:
first, the actuator is actuated by the screwdriver using the right hand; then
the actuator is latched by the screwdriver using that same right hand, the right hand being available again as a result;
thereafter, the cable is gripped by the right hand and introduced into the conductor rail;
the cable in the introduced state is then transferred from the right hand to the left hand and firmly held by the left hand (which also fixes the contact carrier);
the right hand can now pick up the screwdriver again;
the right hand can now unlatch the actuator.

In the process, the insulating member can be held between the ring finger and the ball of the thumb using the left hand. As a result, the user can only hold the cable between the index finger and the thumb, but not handle and introduce the cable. Therefore, in this example the right hand advantageously carries out all of the movements in succession, this significantly facilitating control and mental concentration during this procedure.

In its actuated position, the actuator is latchable in its actuated position to the contact carrier by rotating the tool, such as the flat-head screwdriver. The rotating movement does not have any motion component in the actuating direction, as opposed to a pivoting movement known from the prior art, so that the locking movement and the actuating movement are strictly independent of one another. For this reason, it is also advantageous for the two flexible portions to be disposed so as to be mutually symmetrical on the actuator, because an equalization of forces takes place in the locked state in this way, which has an advantageous effect on the service life of the actuator.

In one embodiment, the actuating portion of the actuator may have at least in regions, specifically on a base portion, a substantially cuboid, solid, basic shape. The cross section of the actuating portion can thus have a solid rectangular basic shape at least in portions. Alternatively or additionally, the holding portion may have a substantially cuboid, solid main portion. The flexible portions can be integrally molded on this main portion on the side of the cable connections.

These solid portions, individually or conjointly, are advantageous in terms of the stability of the actuator.

In one embodiment, the actuating portion may have two actuating arms which are mutually opposite and are embodied so as to be substantially planar and are disposed so as to be mutually parallel. A void for receiving a region of the clamp spring can remain between the two actuating arms. The actuating arms can be integrally molded on the cuboid base portion.

The two flexible portions of the holding portion of the actuator may be able to be bent apart by said rotation of the screwdriver. The actuator can include an actuating portion for interacting with the clamp spring, and a holding portion for guiding said actuator through the contact carrier and for actuating said actuator by the tool. The flexible portions can be a constituent part of the holding portion. The flexible portions can be disposed on the end side of the actuator. The actuator may be integral and be composed of plastics material, such as fiberglass-reinforced polyamide, and be produced by the injection-molding method, for example. The flexible portions may be assigned to the holding portion of the actuator and be integrally molded on the cuboid main portion of the actuator on the side of the cable connections. The flexible portions can in each case include a latching means, such as a latching face, e.g., a latching plate having said latching face, on the end side, said latching face being in each case connected to the main portion by an elastically deformable latching arm. Proceeding from the respective main portion and/or base portion, the latching arms and the actuating arms can point in mutually opposite directions.

The contact carrier can compose mating latching means, such as mating latching faces, within its guide channel, said mating latching means potentially being formed by latching clearances, for example.

In the actuated state of the actuator, the latching faces of the actuator can be situated close to the mating latching faces of the contact carrier.

In the non-latched state of the actuator, the contact plates of the two flexible portions can lie in one plane and be separated by a slot. The screwdriver is able to be introduced into this slot, so as to penetrate the slot and press onto an engagement face, and onto an engagement portion of the holding portion, in order to actuate the actuator, transferring the latter from its non-actuated position to its actuated position.

In the actuated state, i.e., when the actuator is in its actuated position, the screwdriver which presses onto the engagement face/engagement portion can be rotated, as a result of which the slot is widened and the flexible portions bend apart, such as at the end sides. As a result, the latching plates are moved apart and can plunge into the latching clearances, for example. The latching faces and the mating latching faces can in this way abut one another and latch to one another, or at least be held together by static friction, while the spring force presses the actuator, counter to the actuating direction thereof, in the direction of the cable connection side, i.e., in the direction toward the cable connection side. The side from which the cable/the electrical conductor is introduced is referred to as the cable connection side herein.

This latching mechanism is released only when the actuator is pressed slightly in the actuating direction again—thus re-actuated from the point of view of the user—and the flexible portions, such as their latching arms, reversibly snap toward one another and reassume their initial position, and the actuator moves back in the direction of its non-actuated initial position as a result of the restoring spring force.

In some embodiments, the locking rotation of the screwdriver may take place in any arbitrary direction, as a result of which the self-explanatory operation is designed to be even more intuitive. In this instance, the flexible portions are in each case advantageously bent apart by a rotation toward the right as well as by a rotation toward the left of the screwdriver.

### BRIEF DESCRIPTION OF THE SEVERAL VIEWS OF THE DRAWINGS

Embodiments of the present disclosure are illustrated in the drawings and will be explained in more detail below.

FIG. 1a shows a contact carrier having a non-actuated actuator in a transparent illustration.

FIG. 1b shows the aforementioned illustration having a flat-head screwdriver applied to the actuator.

FIG. 2a shows the actuated actuator while being moved to its latching position.

FIG. 2b shows the actuator in its actuated position latched to the contact carrier.

The Figures contain to some extent simplified, schematic illustrations. To some extent, identical reference signs are used for the same but potentially not identical elements.

Different views of identical elements may be two different scales. Directional indications such as, for example, “left,” “right,” “top” and “bottom” are to be understood with reference to the respective figure and may vary in respect of the illustrated object in the individual illustrations.

### DETAILED DESCRIPTION

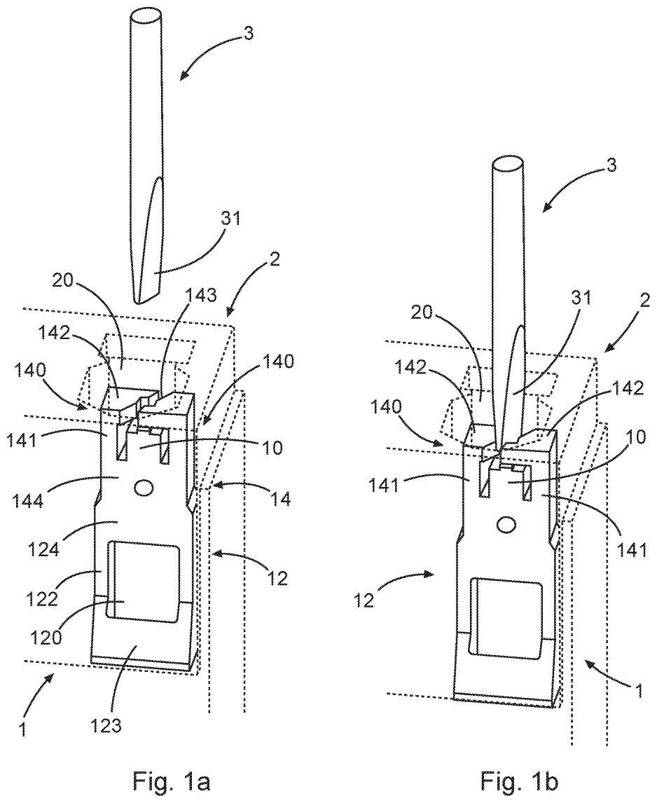

FIGS. 1a and 1b show in each case a contact carrier 2 having a guide channel 20, and an actuator 1 which is in a non-actuated position and disposed in the guide channel 20, in a transparent illustration. The contact carrier 2 as well as the actuator 1 are a constituent part of a cable connecting device.

A flat-head screwdriver 3 having an end portion 31, which is flattened on both sides, is shown above the contact carrier 2 in FIG. 1a. In FIG. 1b, the flat-head screwdriver 3, by way of its end portion 31, is already applied to the actuator 1, as will be explained in more detail hereunder.

The actuator 1 comprises a holding portion 14 and an actuating portion 12 for actuating a clamp spring (not shown), more specifically a clamping leg of this clamp spring, which, conjointly with a conductor rail, likewise not shown, is at least in regions disposed in the contact carrier 2, so as to, by way of the clamping legs of the clamp spring, press an electrical conductor, for example the strand of an electrical cable, which is likewise not shown and is introduced into the contact carrier 2, against a contact region of the conductor rail and in this way connect said strand thereto in an electrically conducting manner and mechanically clamp it thereon.

If the strand of the cable/the electrical conductor is sufficiently stiff, it suffices for the strand/the conductor emanating from the direction of the cable connection side, from above in the drawing, to be pushed between the clamping legs of the clamp spring and the contact region of the conductor rail. In this instance, the actuator 1 serves only for optionally releasing the electrical conductor/the electrical cable from the conductor rail later on, and does not have to be actuated when connecting this cable. This connecting method is also referred to as the so-called “push-in” method and has gained a reputation as a comfortable and user-friendly connecting method.

However, if the strand/the conductor is not sufficiently stiff for this purpose and also not provided with a strand end sleeve, it may however be unfortunately necessary in individual cases that the actuator 1 is also actuated when connecting. The manual operation in this instance can indeed be more problematic, because the contact carrier 2 then has to be manually held, the cable/the conductor has to be simultaneously manually introduced into the contact carrier 2, and the actuator 1 has to be simultaneously manually actuated. In order for this issue to be addressed in an advantageous manner it will be demonstrated hereunder how the actuator 1 in its actuated position advantageously latches to the contact carrier 2, and can be released again intuitively without great effort so as to be able to also comfortably connect a strand which is not as stiff.

The actuating portion 12 of the actuator 1 comprises a cuboid base portion 124 on which two planar actuating arms 122, which lie opposite one another in parallel, are integrally molded. A void 120, which can be utilized for receiving regions of the clamp spring, such as when the latter is actuated, for example, and can contribute to a compact construction mode of the cable connecting device, is formed between the two actuating arms 122. The two actuating arms 122 are connected at the end side by an actuating web 123 which is provided for actuating the clamping leg of the clamp spring.

The holding portion 14 has a cuboid main portion 144 which adjoins the cuboid base portion 124 of the actuating portion 12. The holding portion 14 comprises two flexible portions 140 which are disposed so as to be mutually opposite. Each of these two flexible portions 140 comprises a latching arm 144 which is integrally molded on the main portion 144 and, proceeding from the main portion 144, runs in the direction of the cable connection side, toward the top in the drawing.

The flexible portions 140 comprise in each case a latching plate which is integrally molded on the ends of the latching arms 141 and which forms a latching face 142 on the cable connection side, illustrated on an upper end of the actuator 1 in the drawing.

The latching arms 141 are integrally molded on the main portion 144 of the holding portion 14 and point upward in the drawing. The actuating arms 122 are integrally molded on the base portion 124 of the actuating portion 12 and point downward in the drawing. In this way, the latching arms 141 and the actuating arms 122, proceeding from the main portion 144, or from the base portion 124, point in mutually opposite directions.

An engagement portion 10 is formed between the two latching arms 141.

The two latching plates are separated by a slot 143 into which the flat-head screwdriver 3 is introduced by way of its end portion 31 so as to be applied to the engagement portion 10 of the actuator 1, and to move the actuator 1 from its non-actuated position to its actuated position shown thereunder, from top to bottom in the drawing.

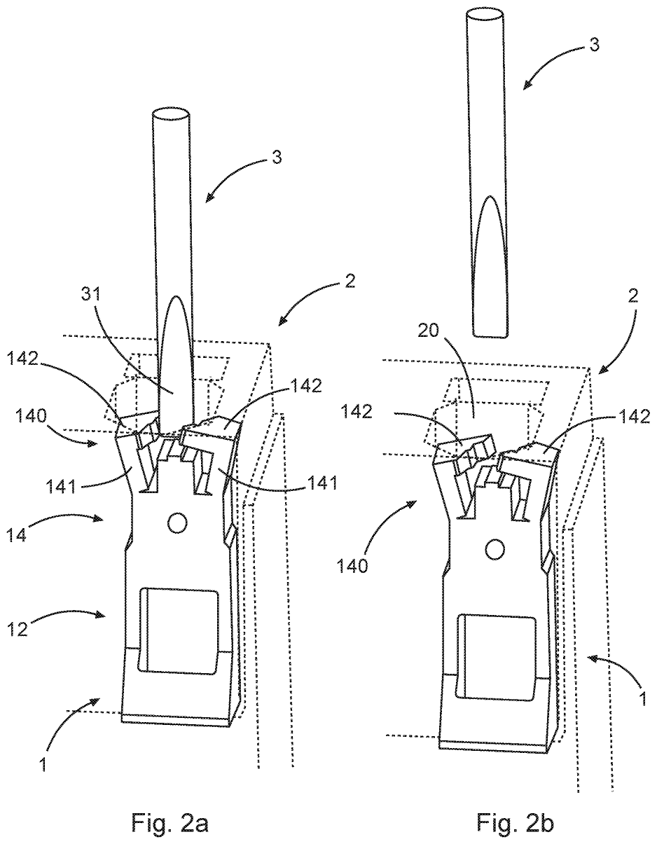

FIGS. 2a and 2b show the actuator 1 in this actuated position, which it has assumed by pressing down the flat-head screwdriver 3 applied to its engagement portion 10. It can be readily seen that the actuator 1 has been pressed into the guide channel 20 of the contact carrier 2, and is now introduced deeper into the guide channel 20 than in the preceding illustrations, and into the contact carrier 2, and is latched to the contact carrier 2 in the guide channel 20.

FIG. 2a shows the actuator 1 during the procedure of latching. It can be readily seen here that the two latching plates, including their latching faces 142, are moved apart by rotating the flat-head screwdriver 3 introduced into the slot 143, and the associated flexible portions 140, which comprise the latching plates 142 as well as the latching arms 131, and are bent apart as well.

FIG. 2b shows the actuator 1 in the latched state. If the flat-head screwdriver 3 is extracted from the contact carrier 2 toward the top in this rotated/latched position, the actuator 1 tilts in the contact carrier 2. For this purpose, the contact carrier 2 can have an undercut with mating latching faces, which is not shown in the drawing, said mating latching faces being engaged from behind by the latching faces 142 of the actuator 1. In this state, an electrical conductor which is composed of a thin strand can also be inserted into the cable connecting device without great effort.

For unlatching—and for electrically contacting the electrical conductor-the actuator 1 in the case of an introduced electrical conductor has only to be briefly nudged by the flat-head screwdriver 3 on the engagement portion 10 of said actuator 1, be slightly re-actuated, in such a way that said actuator 1 unlatches from the contact carrier 2 again and snaps back in the direction of the cable connecting site as a result of the restoring spring force of the clamp spring, upward in the drawing, while the electrical conductor, which in this case is composed of the thin strand, for example, is electrically contacted and mechanically fixed with only little manual effort.

Even though various aspects or features of the invention are shown in each case in combination in the figures, it is apparent to a person skilled in the art—unless otherwise indicated that the combinations shown and discussed are not the only possible ones. In particular, corresponding units or feature complexes from different exemplary embodiments may be interchanged with each other. In other words, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A cable connecting device, comprising:
a contact carrier;
at least one conductor rail; and
at least one actuator which, in an actuated position, is latchable to the contact carrier,
wherein the actuator has two flexible portions which are able configured to be bent apart for latching the actuator to the contact carrier.

2. The cable connecting device as claimed in claim 1, wherein guiding of the actuator is provided and maintained when actuating and latching the actuator, and wherein the actuator is in a latched state on the contact carrier and/or on the conductor rail.

3. The cable connecting device as claimed in claim 1, wherein the actuator is actuatable by a flat-head screwdriver and is movable in a translatory manner into a guide channel of the contact carrier so as to actuate a clamp spring of the cable connecting device.

4. The cable connecting device as claimed in claim 3, wherein a slot in which the flat-head screwdriver engages when the actuator is actuated, is formed between the two flexible portions.

5. The cable connecting device as claimed in claim 4, wherein the two flexible portions of the actuator are configured to be bent apart by rotating the screwdriver introduced between the two flexible portions.

6. The cable connecting device as claimed in claim 5, wherein the two flexible portions of the actuator are configured to be bent apart irrespective of the rotating direction of the screwdriver.

7. The cable connecting device as claimed in claim 1, wherein each respective flexible portion has one latching arm and one latching plate which is integrally molded on the latching arm and has a latching face for latching to the contact carrier.

8. The cable connecting device as claimed in claim 1, wherein the contact carrier has one guide channel for each respective actuator, two mating latching faces for interacting with the latching faces of the actuator, in order for the actuator to latch in its actuated position, being disposed in or on each guide channel.

9. An actuator for a cable connecting device, the actuator comprising:
two flexible portions configured to be bent apart for latching the actuator to a contact carrier, wherein each respective flexible portion has one latching arm and one latching plate, wherein the latching plate is integrally molded on the latching arm and has a latching face for latching to the contact carrier.

10. The actuator as claimed in claim 9, wherein a slot, in which a flat-head screwdriver engages when the actuator is actuated, is formed between the respective latching plates of the two flexible portions.

11. The actuator as claimed in claim 10, wherein the actuator comprises a holding portion and an actuating portion, wherein the two flexible portions are assigned to the holding portion.

12. The actuator as claimed in claim 11, wherein the holding portion, adjacent to the actuating portion, has a substantially cuboid main portion on which the flexible portions are integrally molded.

13. The actuator as claimed in claim 12, wherein the actuating portion of the actuator, adjacent to the cuboid main portion, comprises a cuboid base portion and, adjoining the base portion, has two mutually opposite actuating arms which are embodied to be substantially planar and disposed to be mutually parallel.

14. The actuator as claimed in claim 13, wherein a void for receiving a region of a clamp spring, when the clamp spring is actuated by the actuator, remains between the two actuating arms.

15. The actuator as claimed in claim 13, wherein the latching arms and the actuating arms point in opposite directions.
